(19) United States
(12) Patent Application Publication
(10) Pub. No.: US 2007/0246081 A1
(43) Pub. Date: Oct. 25, 2007

(54) METHODS AND APPARATUS FOR CLEANING A SUBSTRATE

(76) Inventors: Wei Lu, Fremont, CA (US); Jianshe Tang, San Jose, CA (US); Alexander Sou-Kang Ko, Santa Clara, CA (US); Nelson A. Yee, Redwood City, CA (US); Bo Xie, Sunnyvale, CA (US); John Tseng-Chung Lee, San Jose, CA (US); Rick R. Endo, San Carlos, CA (US)

Correspondence Address: DUGAN & DUGAN, PC, 55 SOUTH BROADWAY, TARRYTOWN, NY, 10591, US

(21) Appl. No.: 11/690,628

(22) Filed: Mar. 23, 2007

Related U.S. Application Data
(60) Provisional application No. 60/785,921, filed on Mar. 24, 2006.

(51) Int. Cl. B08B 3/00; B08B 7/00

(52) U.S. Cl. 134/33; 134/34; 134/26

(57) ABSTRACT

The present invention provides methods, apparatus, and systems for cleaning a substrate that include a controller and a nozzle coupled to the controller. The controller is adapted to direct the nozzle to dispense a uniform fluid spray pattern onto a substrate. The controller is adapted create the uniform fluid spray pattern by adjusting at least one operational parameter of the nozzle to cause a predefined percentage of droplets to be within a predetermined size range. Numerous other aspects are disclosed.

The present application claims priority to U.S. Provisional Patent Application Ser. No. 60/785,921, filed Mar. 24, 2006 and entitled “METHODS AND APPARATUS FOR CLEANING SUBSTRATE”, (Docket No. 10841/L) which is hereby incorporated by reference herein in its entirety.

### CROSS-REFERENCE TO RELATED APPLICATIONS

The present application is also related to U.S. patent application Ser. No. ______ filed on even data herewith and entitled “METHODS AND APPARATUS FOR CLEANING A SUBSTRATE” which is hereby incorporated by reference herein in its entirety.

### FIELD OF THE INVENTION

The present invention relates to methods and apparatus for semiconductor substrate cleaning and more particularly to jet sprays used in substrate cleaning.

### BACKGROUND

Substrate cleaning is an important step of the semiconductor device manufacturing process. If a substrate is improperly cleaned, one or more devices formed on the substrate may be damaged. Consequently, semiconductor device manufacturing yield may be adversely affected by improper cleaning. Thus what is needed are improved methods to reliably and efficiently clean substrates during semiconductor device manufacturing.

### SUMMARY

In some aspects, the present invention provides a method of cleaning a substrate that includes adjusting operational parameters of a nozzle so as to produce a uniform fluid spray pattern; and employing the uniform fluid spray pattern to clean a substrate.

In other aspects, the present invention provides a method of cleaning a substrate including supplying a first fluid and a second fluid to a nozzle; adjusting a rate of flow of the first fluid and the second fluid to the nozzle; adjusting a height of the nozzle above a substrate; wherein the adjusting the rate of flow and the height of the nozzle results in a uniform fluid spray pattern having a predefined percentage of droplets in the fluid spray pattern within a predetermined size range; sweeping the uniform fluid spray pattern over a substrate to clean the substrate; and rotating the substrate.

In yet other aspects, the present invention provides an apparatus for cleaning a substrate that includes a controller and a nozzle coupled to the controller. The controller is adapted to direct the nozzle to dispense a uniform fluid spray pattern onto a substrate. The controller is adapted create the uniform fluid spray pattern by adjusting at least one operational parameter of the nozzle.

In still yet other aspects, the present invention provides a system for cleaning a substrate that includes a first fluid supply; a second fluid supply; a first flow controller coupled to the first fluid supply; a second flow controller coupled to the second fluid supply; a main controller coupled to the first and second flow controllers; a nozzle coupled to the first and second flow controllers, the nozzle being adapted to receive a first and second fluid, and to dispense a mixture of the first and second fluid; an actuator coupled to the nozzle and the main controller; and a substrate support disposed to rotate a substrate below the nozzle. The main controller is adapted to adjust the first and second flow controllers to control a rate of fluid flow through the nozzle. The main controller is adapted to adjust the actuator to control a distance between the nozzle and a substrate on the substrate support. The main controller is also adapted to adjust the first and second flow controllers and the actuator to cause a predefined percentage of droplets to be within a predetermined size range.

Other features and aspects of the present invention will become more fully apparent from the following detailed description, the appended claims and the accompanying drawings.

### BRIEF DESCRIPTION OF THE FIGURES

FIG. 1 illustrates a system for cleaning a substrate in accordance with an embodiment of the present invention.

FIGS. 2A-C illustrate exemplary spray patterns provided by the system of FIG. 1 while cleaning a substrate in accordance with an embodiment of the present invention.

FIG. 3 illustrates an exemplary orientation of a spray pattern provided by the system of FIG. 1 in accordance with an embodiment of the present invention.

### DETAILED DESCRIPTION

The present invention provides improved methods and apparatus for substrate cleaning during semiconductor device manufacturing. For example, the present methods and apparatus may provide a highly-uniform jet spray to a substrate surface during cleaning. As will be described below, such a highly-uniform jet spray may improve substrate cleaning by more efficiently removing particles from a substrate surface.

In at least one embodiment, a predetermined percentage of droplets of a highly-uniform jet spray are within a predetermined size range. Further, a predetermined percentage of droplets of the highly-uniform jet spray are within a predetermined tolerance of a mean velocity of the spray. For example, about 97% of the droplets in the jet spray may be about 1 to about 25 microns in diameter, and more preferably about 10 to about 22 microns in diameter, and about 95% of the droplets may be within about ±5% of a mean velocity of the droplets. Exemplary mean velocities are about 30 to about 100 meters/sec, and more preferably about 70 meters/sec.

To achieve a highly-uniform jet spray, one or more spray nozzle parameters may be adjusted. For example, a fluid flow rate to the spray nozzle and/or a distance between the spray nozzle and substrate may be adjusted to create the highly-uniform jet spray. Such a highly-uniform jet spray may improve an efficiency with which particles (e.g., contaminants) are removed from the substrate during cleaning. Additionally or alternatively, the highly-uniform jet spray may reduce and/or eliminate damage to the substrate and/or devices formed thereon by more efficiently cleaning the substrate.

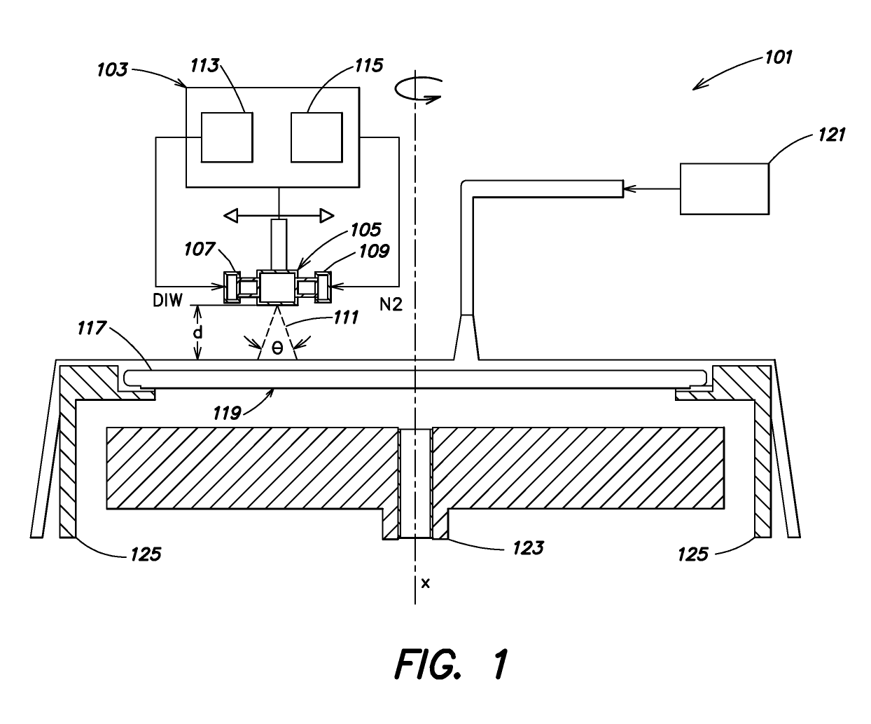

FIG. 1 illustrates a system 101 for cleaning a substrate in accordance with an embodiment of the present invention. The substrate may be, for example, a semiconductor wafer, a glass plate for flat panel displays, or the like.

With reference to FIG. 1, the system 101 may include a control apparatus 103 coupled to a nozzle 105 and adapted to employ the nozzle 105 to provide a spray pattern to a surface of a substrate 119. The spray pattern may be provided with a divergent spray angle θ, which in some embodiments may be about 50°, about 60° or about 90° (although a larger or smaller spray angle θ may be employed).

In at least one embodiment, the nozzle 105 may be an Air Atomizing Spray Nozzle such as a Model 1/8JJ High-Capacity Spray Set-up with External Mix or a QuickMist Pressure Spray Set-up with Internal Mix, manufactured by Spraying Systems Co. of Wheaton, Ill. Both of the above spray nozzles may provide divergent jet sprays with a flat cross-sectional spray pattern. Other nozzle types may be used. Note that in such embodiments, an acceleration tube is not required.

Referring to FIG. 1, the control apparatus 103 may be coupled to first input 107 of the nozzle 105. Further, the control apparatus 103 may be coupled to a second input 109 of the nozzle 105. The control apparatus 103 may be adapted to provide one or more fluids (e.g., gases or liquids) to the nozzle 105 at a predetermined flow rate such that the nozzle 105 may provide a desired uniform spray pattern 111 to a substrate surface 117. For example, the control apparatus 103 may provide a first fluid, such as deionized water (DIW), to the first input 107 at a predetermined flow rate and a second fluid, such as N₂, to the second input 109 at a predetermined flow rate (or pressure).

In some embodiments, the control apparatus 103 may include and/or otherwise control a first flow controller 113 for controlling a flow of fluid to the first input 107 of the nozzle 105 and a second flow controller 115 for controlling a flow of fluid to the second input 109 of the nozzle 105. For example, the first and second flow controllers 113, 115 may be valves, mass flow controllers, or the like.

As stated, the nozzle 105 may employ internal mixing, in which the fluids input to the first and second inputs 107, 109 of the nozzle 105 are mixed within the nozzle 105 to form an atomized spray. Alternatively, the nozzle 105 may employ external mixing, in which the fluid input to the first input 107 of the nozzle 105 is mixed with the fluid input to the second input 109 of the nozzle 105 after the fluids leave the nozzle 105 so as to form an atomized spray (e.g., the fluid inputs may converge and mix after leaving the nozzle 105). Conventional divergent air-atomizing nozzles that employ external mixing or internal mixing may be used, for example. (Note that external-mixing nozzles may provide longer nozzle life by avoiding nozzle wear, and therefore, are preferred in some embodiments of the invention.)

In addition to providing one or more fluids to the nozzle 105, or as an alternative, the control apparatus 103 may be adapted to adjust a nozzle distance (d) from a surface 117 of a substrate 119 to be cleaned such that the nozzle 105 may provide the desired uniform spray pattern 111. Further, the control apparatus 103 may be adapted to move or sweep the nozzle 105 across the surface 117 of the substrate 119 during cleaning (e.g., via one or more motors, lead screws, or the like (not shown)). Additionally or alternatively, the substrate 119 may be moved relative to the nozzle 105. In this manner, the fluid spray pattern 111 may be dispensed from the nozzle 105 to a desired portion of the surface 117 (e.g., the entire surface 117) of the substrate 119.

In the embodiment of FIG. 1, a single control apparatus 103 is employed to provide one or more fluids to the nozzle 105, adjust the nozzle distance d and move the nozzle 105 across the surface 117 of the substrate 119. In some embodiments, a different control apparatus may be employed to adjust the nozzle distance d and/or move the nozzle 105 across the surface 117 of the substrate 119 during cleaning.

Additionally, the system 101 may include an additional fluid source 121 adapted to provide a fluid to the surface 117 of the substrate 119 during cleaning. For example, the additional fluid source 121 may be adapted to provide DIW or a solution of chemical agents to the surface 117 that may serve as a second DIW rinse or chemical medium during cleaning.

The system 101 may include a support 123 adapted to support the substrate 119. Additionally, the system 101 may include and/or be coupled to lift pins 125 adapted to raise and lower the substrate 119 from the support 123, as well as to rotate the substrate 119 during cleaning. In at least one embodiment, four lift pins may be used. Fewer or more lift pins may be employed.

In some embodiments, support pins may be used that are fixed while a plate (such as the support 123) is moved toward the back (e.g., lower surface) of the substrate 119 so as to form a small gap between the plate 123 and the substrate 119. The gap may be filled with DIW and/or one or more chemicals to clean the backside of the substrate 119. In at least one embodiment, the plate 123 may include a megasonic transducer that megasonically energizes the fluid in the gap to clean the substrate's backside and/or couple megasonic power to the substrate 119.

The control apparatus 103 may be employed to tune the spray pattern 111 provided by the nozzle 105 by adjusting (e.g., optimizing) fluid flows to form a highly-uniform spray (e.g., jet spray) and/or adjusting (e.g., reducing) a substrate-nozzle spacing d, which determines spray travel distance, to form the highly-uniform spray. By adjusting fluid flows and/or substrate-nozzle spacing d as described above, the spray pattern 111 provided by the nozzle 105 may include a more uniform droplet size and/or have a more uniform velocity distribution. Further, a velocity of the spray applied to the substrate surface 117 may be increased. In this manner, the present methods and apparatus may provide a more uniform jet spray to a substrate surface when compared to conventional cleaning systems. For example, the more uniform jet spray may include smaller and faster droplets, which may increase particle removal efficiency (PRE) without causing damage to fragile features (e.g., transistors formed on the substrate 119) during cleaning. Consequently, the present methods and apparatus may utilize and tune commercial divergent spray nozzles in wet clean processes to actively remove particles (e.g., contaminants) from a substrate surface 117 without damage during semiconductor device manufacturing.

As a further example, the control apparatus 103 may be employed to provide to the nozzle 105 N₂ gas at a flow rate from about 20 to about 180 cubic feet per hour (SCFH), preferably about 160 SCFH, at a pressure of about 70 psi for an external-mix nozzle and a flow rate of about 56 SCFH at a pressure of about 50 psi for an internal-mix nozzle. The control apparatus 103 also may provide to the nozzle 105 a water flow rate from about 100 to about 200 ml/min at a pressure of about 25 to about 30 psi such that the nozzle 105 may generate the highly-uniform fluid jet spray.

Additionally or alternatively, the control apparatus 103 may be employed to adjust the height (d) between the nozzle 105 and the substrate surface 117 to be about 4 inches or less (e.g., about 100 mm or less), preferably about 25 mm for an external-mixing nozzle and preferably about 16 mm for an internal-mixing nozzle, such that the highly-uniform fluid jet spray 111 may be produced (e.g., a high-velocity jet spray with a more uniform droplet size and velocity distribution compared to sprays produced by conventional systems). In contrast, the nominal spacing for such a nozzle in a targeted application may be over 6 in.

In one exemplary embodiment, about 97% of the droplets in the jet spray may be about 1 to about 25 microns in diameter, and more preferably about 10 to about 22 microns in diameter, and about 95% of the droplets may be within about ±5% of the mean velocity of the droplets (e.g., about 30 to about 100 meters/sec, and more preferably of about 70 meters/sec). However, the percentages, size range, mean velocity range and tolerances described above are exemplary, and larger or smaller percentages, size ranges, mean velocity ranges and/or tolerances may be employed. The small and fast droplets of such a spray may increase PRE without causing damage of fragile device features during cleaning.

In some embodiments, during substrate cleaning as described previously, the substrate 119 may be spun at an appropriate speed, such as about 750 rpm (although a faster or slower rotation speed may be employed). Additionally or alternatively, during substrate cleaning, a second fluid rinse flow of DIW and/or a solution of chemical agents (e.g., in a range of about 800 to about 2000 ml/min) may be dispensed on the substrate 119 (e.g., from the additional fluid source 121). For example, the second fluid rinse may be dispensed at a location of about 20 mm off a central point or axis x of the substrate 119 (or at some other suitable location). Further, the control apparatus 103 may cause the highly-uniform spray pattern 111 provided by the nozzle 105 to sweep back and forth (e.g., from a substrate edge to a substrate center or vice versa). For example, the nozzle 105 may be swept at a sweep rate of about 2 sweeps per minute at a specifically designed sweep profile such that the surface 117 (e.g., the entire surface area of the substrate 119) is uniformly exposed to the spray 111. Other DIW or chemical rinse rates and/or nozzle sweep rates may be used.

Through use of the present methods and apparatus, fluid flows and/or substrate-nozzle spacing may be adjusted to create a highly-uniform jet spray which includes a smaller spray pattern (e.g., less than about 5 mm at the point of contact with the substrate) and faster droplets compared to the spray patterns provided by conventional systems. The highly-uniform jet spray pattern 111 may remove particles (e.g., contaminants) with a high efficiency without damaging fragile features on the substrate 119. The system 101 may be tuned for different wet clean applications, via the fluid flows and/or nozzle-substrate distance d employed, such that a larger or smaller percentage of particles may be removed. The highly-uniform jet spray 111 may have a tight kinetic energy distribution (e.g., between about 0.1 erg/droplet and about 1.6 erg/droplet) and adjustable peak energy (e.g., about 0.8 erg/droplet) based on the nozzle-substrate spacing d. Other energy distributions and/or peak energies may be used.

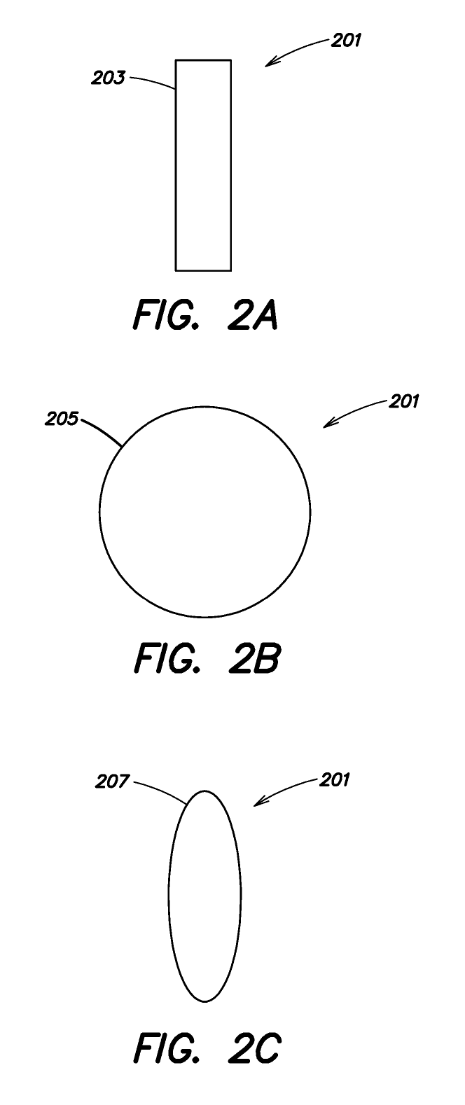

FIGS. 2A-C illustrate exemplary spray patterns that may be employed by the system of FIG. 1 while cleaning a substrate in accordance with an embodiment of the present invention. With reference to FIGS. 2A-C, the highly-uniform spray pattern 111 provided by nozzle 105 may be flat (e.g., rectangular or otherwise shaped) as indicated by reference numeral 203 in FIG. 2A, round as indicated by reference numeral 205 in FIG. 2B or elliptical as indicated by reference numeral 207 in FIG. 2C. However, a spray pattern of a different shape may be provided.

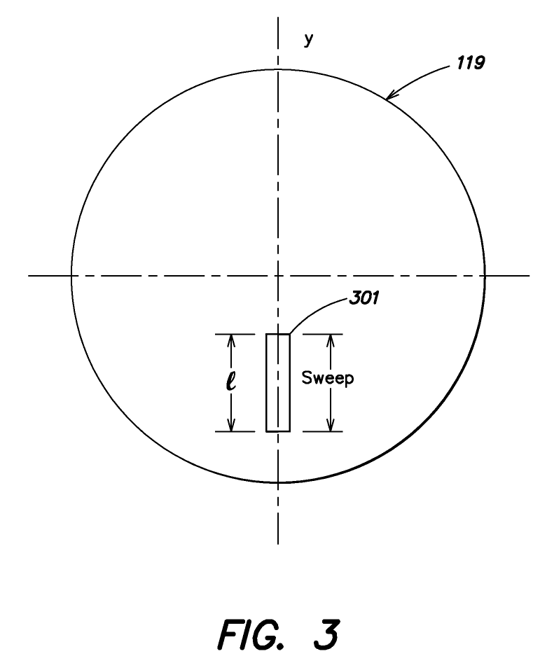

FIG. 3 illustrates an exemplary orientation of a spray pattern 301 provided by the system 101 of FIG. 1 in accordance with an embodiment of the present invention. With reference to FIG. 3, the nozzle spray pattern 301 may be oriented during substrate cleaning such that a sweep length l of the spray pattern 301 may coincide with a y-axis of the substrate 119 along which the spray pattern sweeps. In some embodiments, the sweep length l may be about 30 mm, although other sweep lengths may be used. For example, in some embodiments, the sweep length l is adjustable by the nozzle-substrate distance. The y-axis may be along a radial direction of the substrate 119 to be cleaned. Other orientations and sweep directions may be used.

The foregoing description discloses only exemplary embodiments of the invention. Modifications of the above disclosed apparatus and methods which fall within the scope of the invention will be readily apparent to those of ordinary skill in the art. For instance, a liquid flow of pure DIW, CO2-dissolved DI water, O₃-dissolved DIW, ultra-diluted (e.g., 1 ppm) NH3-DIW and/or some other agent-containing DIW, or another cleaning agent may be provided to the substrate via the nozzle 105.

In one exemplary embodiment, at about a 95 mm nozzle-substrate distance, neither a spray rinse with a DI water flow only from the additional fluid source 121 (FIG. 1) nor a cleaning chemical solution flow from the additional fluid source 121 without a spray rinse from nozzle 105 can achieve a PRE over 50%. However, a spray rinse from nozzle 105 combined with a chemical solution flow from additional fluid source 121 can boost the PRE to approximately 95%.

In some embodiments, PRE by spray rinse with DI flow only from additional fluid source 121 exponentially decreases with increasing nozzle-substrate distance. With the same spray from nozzle 105, the distance can be dialed into a damage-free regime from a damage regime.

During cleaning with spray rinse as depicted in FIG. 1, the substrate spinning speed can be adjusted to control the thickness of the liquid media film on top of a substrate surface. A thicker media film may provide extra cushion protection of fragile features on a substrate surface and/or better transport of particles out and away from substrate surfaces. A thinner media film may expose the substrate surface to more energetic bombardment by high-speed water droplets from nozzle 105 to boost PRE.

Accordingly, while the present invention has been disclosed in connection with exemplary embodiments thereof, it should be understood that other embodiments may fall within the spirit and scope of the invention, as defined by the following claims.

The invention claimed is:

1. A method of cleaning a substrate, comprising:
adjusting operational parameters of a nozzle so as to produce a uniform fluid spray pattern; and
employing the uniform fluid spray pattern to clean a substrate.

2. The method of claim 1 wherein adjusting operational parameters of a nozzle includes adjusting a fluid flow rate to the nozzle.

3. The method of claim 1 wherein adjusting operational parameters of a nozzle includes adjusting a height of the nozzle above the substrate.

4. The method of claim 1 wherein adjusting operational parameters of a nozzle includes adjusting a rate of fluid flow to the nozzle and a height of the nozzle above the substrate to cause a predefined percentage of droplets to be within a predetermined size range.

5. The method of claim 1 wherein the nozzle is adapted to generate a flat fluid spray pattern.

6. The method of claim 1 wherein the nozzle is adapted to generate a round fluid spray pattern.

7. The method of claim 1 wherein the nozzle is adapted to generate a elliptical fluid spray pattern.

8. The method of claim 1 further comprising supplying a first fluid and a second fluid to the nozzle.

9. The method of claim 8 wherein the first fluid is a liquid and the second fluid is a gas.

10. The method of claim 9 further comprising mixing the liquid and the gas external to the nozzle.

11. The method of claim 9 further comprising mixing the liquid and the gas internal to the nozzle.

12. The method of claim 9 further comprising applying a third fluid directly to the substrate.

13. The method of claim 1 further comprising sweeping the nozzle over the substrate as fluid is dispensed by the nozzle.

14. The method of claim 1 further comprising rotating the substrate under the nozzle as fluid is dispensed by the nozzle.

15. A method of cleaning a substrate, comprising:
adjusting a rate of fluid flow to a nozzle and a height of the nozzle above a substrate so as to produce a uniform fluid spray pattern wherein a predefined percentage of droplets in the fluid spray pattern are within a predetermined size range;
sweeping the uniform fluid spray pattern over a substrate to clean the substrate; and
rotating the substrate.

16. The method of claim 15 further comprising supplying a first fluid and a second fluid to the nozzle.

17. The method of claim 16 wherein the first fluid is a liquid and the second fluid is a gas.

18. The method of claim 17 further comprising mixing the liquid and gas external to the nozzle.

19. The method of claim 17 further comprising mixing the liquid and gas internal to the nozzle.

20. The method of claim 17 further comprising supplying a third fluid directly to the substrate during cleaning.

21. A method of cleaning a substrate, comprising:
supplying a first fluid and a second fluid to a nozzle;
adjusting a rate of flow of the first fluid and the second fluid to the nozzle;
adjusting a height of the nozzle above a substrate;
wherein the adjusting the rate of flow and the height of the nozzle results in a uniform fluid spray pattern having a predefined percentage of droplets in the fluid spray pattern within a predetermined size range;
sweeping the uniform fluid spray pattern over a substrate to clean the substrate; and
rotating the substrate.
